(19) United States
(12) Patent Application Publication
(10) Pub. No.: US 2007/0206467 A1
(43) Pub. Date: Sep. 6, 2007

(54) METHOD FOR DISCRIMINATING DISCS

(75) Inventors: Xiang-Sheng Li, Taoyuan County (TW); Wen-Kuan Peng, Taoyuan County (TW); Chien-Chang Huang, Taoyuan County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: QUANTA STORAGE INC., Taoyuan County (TW)

(21) Appl. No.: 11/562,003

(22) Filed: Nov. 21, 2006

(30) Foreign Application Priority Data
Mar. 2, 2006 (TW) 95107125

(51) Int. Cl. G11B 7/00

(52) U.S. Cl. 369/53.2

(57) ABSTRACT

A method for discriminating a disc includes the steps of: detecting that the disc is inserted into an optical drive; starting a roller motor to load the disc; counting the number of operating sensors; counting time of a disk loading procedure; judging whether all of the sensors operate to determine the disc is a primary disc; judging whether the number of the operating sensors decreases to determine the disc is a secondary disc; determining whether a disc loading time exceeds a default time by comparison; and ejecting the disc. If the number of operating sensors is kept the same as the original one and the time of the loading procedure does not exceed a default value, the method goes back to the judging steps to discriminate the disc repeatedly. If the disc loading time exceeds the default time, the disc is ejected.

This application claims the benefit of Taiwan application Serial No. 095107125, filed Mar. 2, 2006, the subject matter of which is incorporated herein by reference.

### BACKGROUND OF THE INVENTION

1. Field of the Invention

The invention relates in general to an optical drive, and more particularly to a method for discriminating a size of a disc and screening out an inaccessible disc when a slot-in optical drive is loading the disc.

2. Description of the Related Art

Because the discs are mainly divided into two types respectively having the sizes of 8 cm and 12 cm, the conventional optical drive typically has a disc loading and unloading mechanism suitable for the two types of discs. As shown in FIG. 1, a conventional slot-in optical drive 10 includes a cone-like and strip-like roller 12 disposed at an inlet 11 of the slot-in optical drive 10, and two sensors 13a and 13b disposed near the roller 12. The sensor 13a senses the inserting of a disc 14 and immediately rotates the roller 12 forward to load the inserted disc 14 into the optical drive 10. A disc-supporting link 15 has symmetrical centering rods 15a and 15b to support the circumference of the disc 14 such that the center of the disc 14 automatically aligns with a center line of a spindle motor 16. Then, under the driving of the roller 12, the centering rods 15a and 15b of the disc-supporting link 15 slide along parallel sliding slots 17a and 17b to transport the center of the disc 14 to the spindle motor 16 such that the spindle motor 16 can rotate the disc 14 to finish the positioning. In addition, when the disc is to be rejected, the roller 12 is reversed to eject the disc 14 out of the optical drive 10. When the disc 14 escapes from the sensor 13b, the roller 12 stops such that the disc 14 to be taken out is held at the inlet 11.

The center position of the disc 14 changes as the size of the disc 14 changes. In this case, the moving distance of the disc-supporting link 15 has to be correspondingly changed, or otherwise the disc 14 which is not positioned will be damaged. Thus, the conventional optical drive 10 has a disc selecting link 18 disposed at a lateral side thereof, and a selectively actuating arm 19 disposed at a rear side thereof to constitute a mechanism of discriminating the disc. When the 8 cm disc 14a is loaded in, the smaller disc cannot touch the disc selecting link 18, and the actuating arm 19 is kept at the original position. When the disc-supporting link 15 is transporting the disc 14, a projecting pin 15c slides in a strip slot 19a of the actuating arm 19 and moves along a sliding slot 17c to rotate the actuating arm 19 about a pivot 19b inserted into a moving slot 101. Thus, a positioning restricting pin 19c of the actuating arm 19 moves along a small slot edge 102a of a cam slot 102 while restricting the disc-supporting link 15 to move by a shorter distance such that the 8 cm disc 14a is moved and positioned.

As shown in FIG. 2, when the 12 cm disc 14b is loaded, the disc 14 with the larger diameter actuates a front end portion 18a of the disc selecting link 18, and the disc selecting link 18 rotates about a fulcrum 18b, such that a rear end portion 18c of the link 18 pushes the actuating arm 19 to move the pivot 19b inwards along the moving slot 101 and the positioning restricting pin 19c enters the larger slot of the cam slot 102. Then, when the disc-supporting link 15 is transporting the disc 14b, the projecting pin 15c slides in the strip slot 19a of the actuating arm 19 and moves along the sliding slot 17c to rotate the actuating arm 19 about the pivot 19b. Thus, the positioning restricting pin 19c moves along a larger slot edge 102b of the cam slot 102 to move the disc-supporting link 15 by a longer distance such that the 12 cm disc 14b is moved and positioned.

Although the conventional optical drive 10 uses the multi-link mechanism to discriminate the size of the disc to load and eject the 8 cm and 12 cm discs, the front end portion 18a of the disc selecting link 18 placed at the inlet 11 tends to be touched by the inserted 8 cm disc which deviates from the normal position, thereby causing the malfunction to damage the disc. Meanwhile, the disc selecting link 18 and the sensors 13a and 13b cannot quick discriminate and eject the disc or the foreign object, which is not suitable for the optical drive, thereby damaging the optical drive and the disc. Consequently, the prior art method of discriminating discs in the optical drive still has problems to be solved.

### SUMMARY OF THE INVENTION

It is therefore an object of the invention to provide a disc discriminating method for detecting the number of operating sensors within a predetermined time of the disk loading procedure to discriminate a size of a disc with the increased speed and reliability of discriminating the disc.

Another object of the invention is to provide a disc discriminating method for quickly discriminating and ejecting an improper disc or a foreign object using a sensing unit so as to protect an optical drive and the disc.

The invention achieves the above-identified objects by providing a method for discriminating a disc including the steps of: detecting that the disc is inserted into a disk drive; starting a roller motor to load the disc; counting the number of operating sensors; counting time of a disk loading procedure; judging whether all of the sensors operate; judging whether the number of the operating sensors decreases; determining whether a disc loading time exceeds a default time by comparison; and ejecting the disc. The disc is judged as a primary disc if all operating sensors operate. The disc is judged as a secondary disc if the number of the operating sensors decreases. If the number of operating sensors is kept the same as the original one and the time of the loading procedure does not exceed a default value, the method goes back to the judging steps to discriminate the disc repeatedly. If the disc loading time exceeds the default time, the disc is ejected to increase the discriminating speed and precision.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a schematic top view showing that a small disc is loaded in a conventional slot-in disk drive.

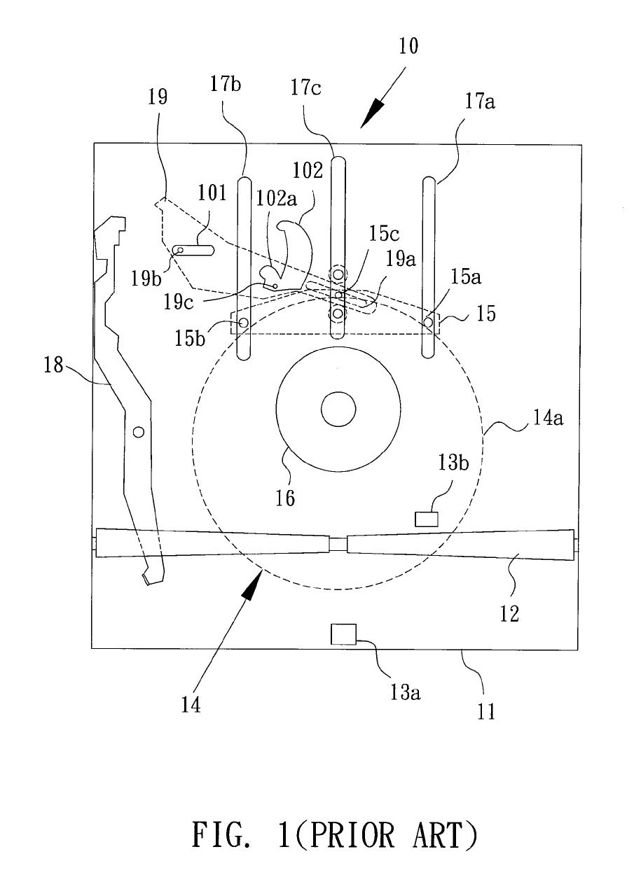

FIG. 2 (Prior Art) is a schematic top view showing that a large disc is loaded in the conventional slot-in disk drive.

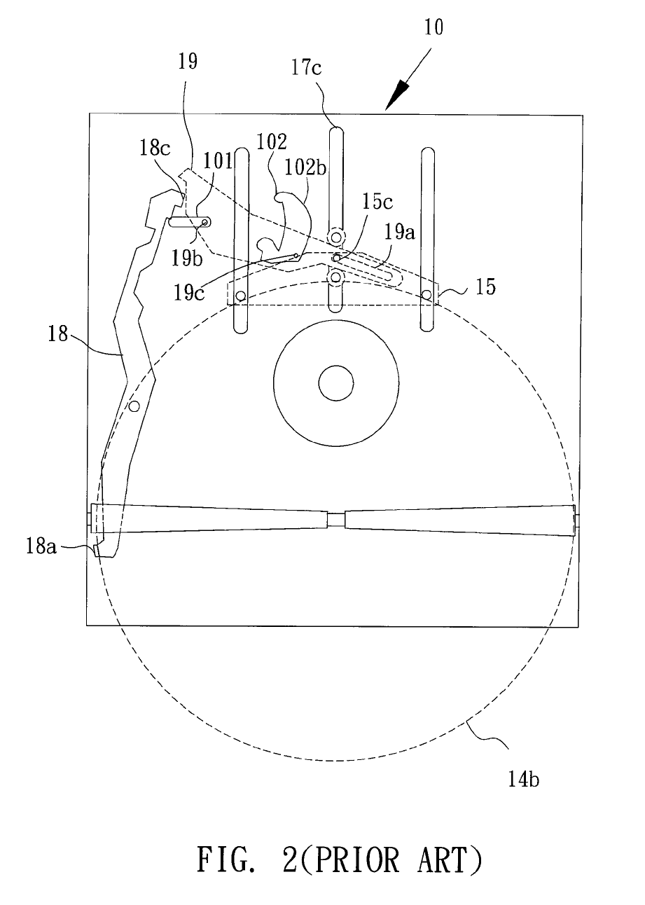

FIG. 3 is a schematic illustration showing an optical drive using a disc discriminating method of the invention.

FIG. 4 is a flow chart showing the disc discriminating method according to the preferred embodiment of the invention.

### DETAILED DESCRIPTION OF THE INVENTION

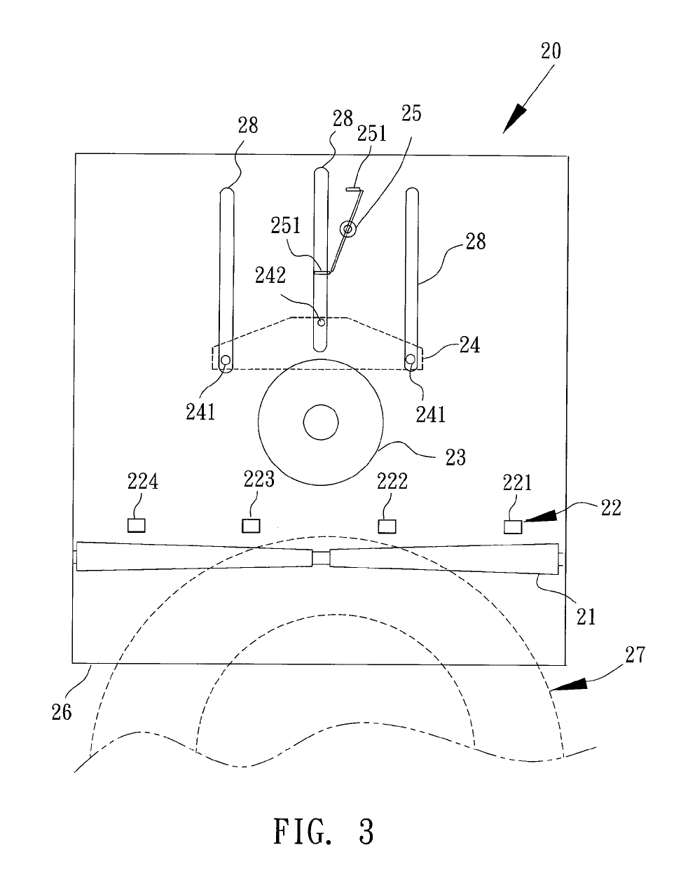

FIG. 3 shows an optical drive 20 using a disc discriminating method of the invention. The optical drive 20 may be a slot-in optical drive or an externally connected disc input/output module. Taking the slot-in optical drive as an example, the optical drive 20 mainly includes a disc input/output mechanism including, for example, a roller 21, a sensing unit 22, a spindle motor 23, a disc-supporting link 24 and a position restricting unit 25. The roller 21 is transversely disposed at an inlet 26 of the optical drive 20. The sensing unit 22 may be a photosensitive type sensing unit or a position restricting switch, and composed of a plurality of sensors 221, 222, 223 and 224, which are disposed at the inlet 26 in a row near the roller 21. In this embodiment, the sensors 221 to 224 are disposed in back of the roller 21. The sensing unit 22 can timely start or stop the roller 21 according to the detected result.

In addition, the spindle motor 23 is disposed near the center of the optical drive 20, and the disc-supporting link 24 is disposed near a back side of the spindle motor 23. Two symmetrical centering rods 241 with respect to the spindle motor 23 are respectively disposed at two ends of the disc-supporting link 24. A positioning restricting pin 242 is disposed at the middle of the disc-supporting link 24. The optical drive 20 is formed with three parallel strip-like sliding slots 28 in back of the spindle motor 23 along the disc input/output direction of a disc 27. The two centering rods 241 and the positioning restricting pin 242 can slide in the strip-like sliding slots 28 such that the disc-supporting link 24 can move along the disc input/output direction of the disc 27. The position restricting unit 25 is disposed adjacent to the sliding slot 28 in which the positioning restricting pin 242 slides. The moving distance of the disc-supporting link 24 is selectively restricted by a position restricting block 251 according to a result of discriminating the disc by the sensing unit 22.

Thus, the optical drive 20 can use the sensing unit 22 to detect the insertion and size of the disc 27, rotate the roller 21 to load the disc 27, and select the corresponding position restricting block 251 of the position restricting unit 25. The centering rod 241 of the supporting link 24 supports the rear circumference of the disc 27 such that the disc 27 is automatically aligned with the center line of the spindle motor 23. Under the guidance of the sliding slot 28, the disc-supporting link 24 is moved back by the distance restricted by the position restricting unit 25 such that the disc 27 reaches the spindle motor 23 and is positioned. When the disc is being ejected, the roller 21 is reversed to output the disc 27 until the number of the operating sensors 221, 222, 223 and 224 is decreased to the predetermined number. Then, the roller 21 is stopped such that the disc 27 to be taken out is held at the inlet 26.

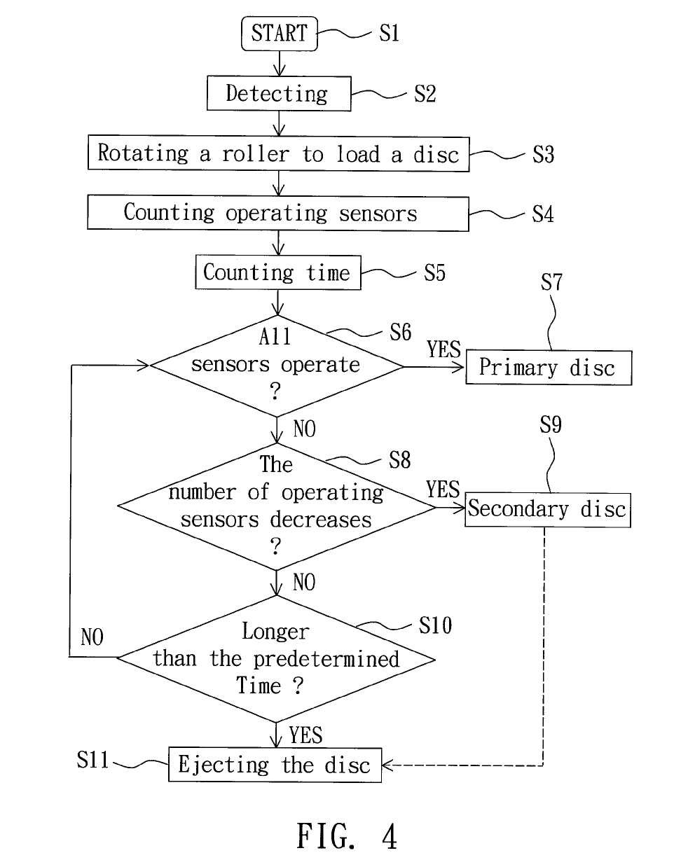

The disc discriminating method of the invention will be described in the following with reference to FIGS. 4 and 3.

In step S1, the disc 27 is inserted into the optical drive 20.

In step S2, the sensing unit 22 senses if any one of the sensors 221 to 224 operates to detect the insertion of the disc 27.

In step S3, when any one of the sensors 221 to 224 starts to operate, the roller 21 is immediately started to rotate to load the disc 27 into the optical drive.

In step S4, the number of operating sensors is counted when the sensing unit 22 detects the inserted disc.

In step S5, the time is counted and the time of loading the disc is recorded when the sensing unit 22 detects the inserted disc.

In step S6, the disc size is determined according to the number of sensors shielded by the disc. In this embodiment, four sensors are used to discriminate the 8 cm disc and the 12 cm disc. The 8 cm disc can shield about three sensors, while the 12 cm disc can shield four sensors. Thus, after the disc is being loaded, the number of operating sensors continuously increases. Whether all the sensors operate is judged according to the counting number of the operating sensors of the sensing unit 22 obtained in step S4. If yes, the method goes to step S7, or otherwise the method goes to step S8.

In step S7, when all of the sensors operate, that is, all the sensors are shielded, the method can judge the disc as a primary disc, which is the 12 cm disc in this embodiment.

In step S8, when not all of the sensors operate, it is judged whether the number of operating sensors decreases. If yes, the method goes to step S9, or otherwise goes to step S10.

In step S9, when the number of operating sensors decreases, it is judged that the disc is a secondary disc, which is the 8 cm disc.

In step S10, when the disc is continuously loaded, not all of the sensors operate, and the number of operating sensors decreases, the disc loading time recorded in step S5 can be compared with the predetermined disc loading time which is set in advance. Because the diameter of the disc is not long and the rotating speed of the roller 21 is very high, the primary disc enables all the sensors to operate within about 0.3 seconds and the secondary disc enables the sensors to operate within about 0.2 to 0.3 seconds in this embodiment. Thus, the method can judge whether the normal disc or the foreign object is inserted according to the disc loading time. If the disc loading time exceeds the predetermined time, the method goes to step S11, or otherwise back to step S6 to discriminate the disc repeatedly.

In step S11, when the disc loading time exceeds the predetermined time, it is judged that the inserted object is the improper disc or the foreign object, and the roller 21 reverses to eject the disc to prevent the object from being jammed in the optical drive.

Thus, the disc discriminating method according to the embodiment of the invention can discriminate the size of the disc according to the number of operating sensors when the disc is loaded. Thus, the optical drive can correctly judge the size of the disc with the high reliability. In addition, the time for the disc to enable all the sensors normally is set as the predetermined time, which is compared with the disc loading time, such that the improper disc or the wrongly inserted foreign object can be discriminated quickly and then ejected quickly when the loading is not completely finished. Thus, it is possible to prevent the object or disc from jamming in the disk drive and to protect the disk drive and the disc from damage.

Meanwhile, the disc discriminating method of the invention may also be suitable to the optical drive suitable for only one size of discs to screen out the improper discs. For example, the method is suitable for the optical drive which can only access the 12 cm disc. In the steps of the disc discriminating method, after the disc has been judged as the secondary disc in step S9, as shown in the dashed line of FIG. 4, the procedure goes to step S11 to reverse the roller 21 to eject the improper disc to prevent the jamming in the optical drive. Thus, the invention can quickly discriminate and eject the improper disc or the wrongly inserted foreign object according to the decrease of the number of operating sensors and the excess of the predetermined time.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for discriminating a disc in an optical drive having a plurality of sensors, the method comprising the steps of:
(1) detecting that the disc is inserted into the optical drive;
(2) loading the disc;
(3) counting the number of operating sensors when the inserted disc is detected;
(4) counting time when the inserted disc is detected;
(5) judging whether all of the operating sensors operate, wherein the disc is judged as a primary disc if all operating sensors operate;
(6) judging whether the number of the operating sensors decreases, wherein the disc is judged as a secondary disc if the number of the operating sensors decreases;
(7) determining whether a disc loading time exceeds a default time by comparison, and repeating step (5), (6) and (7) until the disc loading time exceeds the default time; and
(8) ejecting the disc.

2. The method according to claim 1, wherein the disc is detected to be inserted into the optical drive when any one of the sensors operates in step (1).

3. The method according to claim 1, wherein the optical drive further comprises a roller, which is rotated to load the disc in step (2).

4. The method according to claim 3, wherein step (8) comprises reversing the roller to eject the disc.

5. The method according to claim 1, wherein step (4) comprises a time counting step for recording a time of loading the disc.

6. The method according to claim 5, wherein step (5) comprises judging whether all of the sensors operate according to the counted number of operating sensors in step (3).

7. The method according to claim 1, wherein step (6) comprise judging whether the number of operating sensors decreases according to the counted number of operating sensors in step (3).

8. The method according to claim 1, wherein when the disc is judged as the secondary disc in step (6), the method enters step (8) to eject the disc.

9. The method according to claim 1, wherein the primary disc is a 12 cm disc and the secondary disc is an 8 cm disc.

10. The method according to claim 1, wherein, in step (7), the disc loading time is the time counted in step (4).

11. The method according to claim 1, wherein the default time is the time when the primary disc is loaded to enable all of the sensors to operate.

12. The method according to claim 10, wherein the default time equals 0.3 seconds.
